(19) United States
(12) Patent Application Publication
(10) Pub. No.: US 2022/0111686 A1
(43) Pub. Date: Apr. 14, 2022

(54) SIDEWALL CONSTRUCTION FOR A TIRE

(71) Applicant: The Goodyear Tire & Rubber Company, Akron, OH (US)

(72) Inventors: Gilles Reichling, Vichten (LU); Jan Frans Leyssens, Leglise-Beheme (BE); Pascal Pletschette, Mullendorf (LU); Hendrikus Lambertus Johannes Maria De Wit, Diekirch (LU); Paul Welbes, Schrondweiler (LU)

(21) Appl. No.: 17/070,027

(22) Filed: Oct. 14, 2020

(51) Int. Cl. B60C 15/06; B60C 9/28

(52) U.S. Cl. CPC B60C 15/0653; B60C 2009/0491; B60C 9/28

(57) ABSTRACT

A bead portion of a tire includes: a bead portion including a core; a first filler arranged at the core; a carcass extending around the core and the first filler and radially inward adjacent an axially inner side of the core, the carcass further extending axially outward adjacent the core and radially outward adjacent the core; a second filler extending both axially and radially beyond the first filler, the second filler overlapping the first filler, an outermost end of the second filler being positioned radially outward from the first filler; a first chafer disposed at the second filler; a second chafer extended about the carcass; and a flipper extending radially inward from a position axially adjacent the first filler. The second filler is embedded at a convergence of the first chafer and a sidewall.

### FIELD OF THE INVENTION

The present invention relates to a tire provided with a unique sidewall/bead construction.

### BACKGROUND OF THE INVENTION

A factor for reducing the endurance of a bead unit includes delamination (separation) between a carcass and a rubber member contacting the outer side in the tread width direction of the carcass. One factor causing the separation may be stress generated by upthrust from a rim. Due to this stress, shear strain may cause delamination between the carcass and the bead.

In recent years, with an increased awareness for environmental concerns, the reduction of the tire weight has been desired. By reducing the tire weight, it may be possible to reduce rolling resistance, resulting in the reduction of fuel consumption. A tire with the aforementioned structure may increase tire weight. By shortening a bead filler as compared with a standard bead filler, reduction of the bead weight may still be possible. In a tire with a shortened bead filler, since stress generated by curvature and deformation of a side wall portion acts toward the vicinity of a front end portion of the shortened bead filler, separation may occur near the front end portion of the bead filler. In this regard, another reinforcing member, or flipper, may be provided at the outer side in the tire radial direction of the bead core and bead filler.

### SUMMARY OF THE INVENTION

A bead portion of a tire in accordance with the present invention includes: a bead portion of a tire including a bead core; a first bead filler arranged at a radially outer side of the bead core; a carcass extending around the bead core and the first bead filler and radially inward adjacent an axially inner side of the bead core, the carcass further extending axially outward adjacent a radially inner side of the bead core and radially outward adjacent an axially outer side of the bead core; a second bead filler extending both axially and radially beyond the first bead filler, the second bead filler overlapping the first bead filler, an outermost end of the second bead filler being positioned radially outward from the first bead filler; a first chafer disposed at an axially outer side of the second bead filler; a second chafer extended about a radially inner end of the first carcass; and a flipper extending radially inward from a position axially adjacent an axially outer side of the first bead filler. The second bead filler is embedded at a convergence of the first chafer and a sidewall of the tire.

According to another aspect of the bead portion, the second bead filler extends both axially and radially beyond a first bead filler outer end portion.

According to still another aspect of the bead portion, the second bead filler overlaps a first bead filler outer end portion.

According to yet another aspect of the bead portion, a radially outermost end of the second bead filler outer end portion is positioned at the first bead filler outer end portion.

According to still another aspect of the bead portion, a radially inner end portion of the second bead filler is positioned at a radially outer side of the bead core.

According to yet another aspect of the bead portion, a radially inner end portion of the second bead filler is positioned at a radially outermost surface of the bead core.

According to still another aspect of the bead portion, the second bead filler contacts the carcass.

According to yet another aspect of the bead portion, the second bead filler contacts the first chafer.

According to still another aspect of the bead portion, the second bead filler is embedded at a convergence of a radially outer portion of the first chafer and a radially inner portion of the side rubber layer.

According to yet another aspect of the bead portion, the first bead filler, the second bead filler, and the flipper further decrease rolling resistance of the tire.

A method in accordance with the present invention stiffens a bead portion of a tire. The method includes the steps of: arranging a first bead filler at a radially outer side of a bead core; extending a carcass around the bead core and the first bead filler; extending the carcass radially inward adjacent an axially inner side of the bead core; extending the carcass axially outward adjacent a radially inner side of the bead core; extending the carcass radially outward adjacent an axially outer side of the bead core; arranging a second bead filler both axially and radially beyond the first bead filler; overlapping the first bead filler with the second bead filler; positioning an outermost end of the second bead filler radially outward from the first bead filler; arranging a first chafer at an axially outer side of the second bead filler; and embedding the second bead filler at a convergence of the first chafer and a sidewall of the tire.

According to another aspect of the method, a further step includes extending a second chafer about a radially inner end of the carcass.

According to still another aspect of the method, a further step includes extending a flipper radially inward from a position axially adjacent an axially outer side of the first bead filler.

According to yet another aspect of the method, a further step includes extending the flipper axially inward adjacent a radially inner side of the bead core.

According to still another aspect of the method, a further step includes extending the flipper radially outward to a position axially adjacent two separate parts the carcass and a radially outermost end of the first bead filler.

### Definitions

As used herein and in the claims:

“Apex” means an elastomeric filler located radially above the bead core and between the plies and the turnup ply.

“Annular” means formed like a ring.

“Aspect ratio” means the ratio of a tire section height to its section width.

“Aspect ratio of a bead cross-section” means the ratio of a bead section height to its section width.

“Asymmetric tread” means a tread that has a tread pattern not symmetrical about the centerplane or equatorial plane (EP) of the tire.

“Axial” and “axially”, or “in a tread width direction”, refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane (EP) of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane (EP) of the tire. If multiple plies are present, the ply cords run at opposite angles in alternating layers.

“Breakers” means at least two annular layers or plies of parallel reinforcement cords having the same angle with reference to the equatorial plane (EP) of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls, and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” and “circumferentially” mean lines or directions extending along the perimeter of the surface of the annular tire parallel to the equatorial plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane (EP). The “cord angle” is measured in a cured but uninflated tire.

“Crown” means that portion of the tire within the width limits of the tire tread.

“Denier” means the weight in grams per 9000 meters (unit for expressing linear density). “Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Evolving tread pattern” means a tread pattern, the running surface of which, which is intended to be in contact with the road, evolves with the wear of the tread resulting from the travel of the tire against a road surface, the evolution being predetermined at the time of designing the tire, so as to obtain adhesion and road handling performances which remain substantially unchanged during the entire period of use/wear of the tire, no matter the degree of wear of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made, that forms the basic element of filaments; characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High tensile steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360° rotation about another filament or strand.

“Load range” means load and inflation limits for a given tire used in a specific type of service as defined by tables in The Tire and Rim Association, Inc.

“Mega tensile steel (MT)” means a carbon steel with a tensile strength of at least 4500 MPa at 0.20 mm filament diameter.

“Net contact area” means the total area of ground contacting elements between defined boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal inner pressure” means the air pressure corresponding to the air pressure at the time of measuring tire dimensions.

“Normal load” means a maximum load (the maximum loading capability) of a single wheel in the applicable size.

“Normal rim” means a standard rim in an applicable size.

“Normal tensile steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” mean directions radially toward or away from the axis of rotation of the tire.

“Radial ply structure” means the one or more carcass plies or which at least one ply has reinforcing cords oriented at an angle of between 65° and 90° with respect to the equatorial plane (EP) of the tire.

“Radial ply tire” means a belted or circumferentially-restricted pneumatic tire in which at least one ply has cords which extend from bead to bead and the ply is laid at cord angles between 65° and 90° with respect to the equatorial plane (EP) of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section height” means the radial distance from the nominal rim diameter to the outer diameter of the tire at its equatorial plane (EP).

“Section width” means the maximum linear distance parallel to the axis of the tire and between the exterior of its sidewalls when and after it has been inflated at normal pressure for 24 hours, but unloaded, excluding elevations of the sidewalls due to labeling, decoration, or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super tensile steel (ST)” means a carbon steel with a tensile strength of at least 3650 MPa at 0.20 mm filament diameter.

“Tenacity” is stress expressed as force per unit linear density of the unstrained specimen (gm/tex or gm/denier).

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

“Vertical deflection” means the amount that a tire deflects under load.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### BRIEF DESCRIPTION OF DRAWINGS

FIG. 1 is a schematic cross sectional view along a tire radial direction and a tread width direction of a tire in accordance with the present invention.

FIG. 2 is an enlarged cross sectional view of part of the tire of FIG. 1.

### DESCRIPTION OF EXAMPLES OF THE PRESENT INVENTION

In the following description of the drawings, the same or similar reference numerals are used to designate the same or similar parts. It may be appreciated that the drawings are schematically shown and the ratio and the like of each dimension may be different from these examples. Therefore, the specific dimensions must be determined in view of the below explanation. It is needless to say that relations and ratios among the respective dimensions may differ among the diagrams.

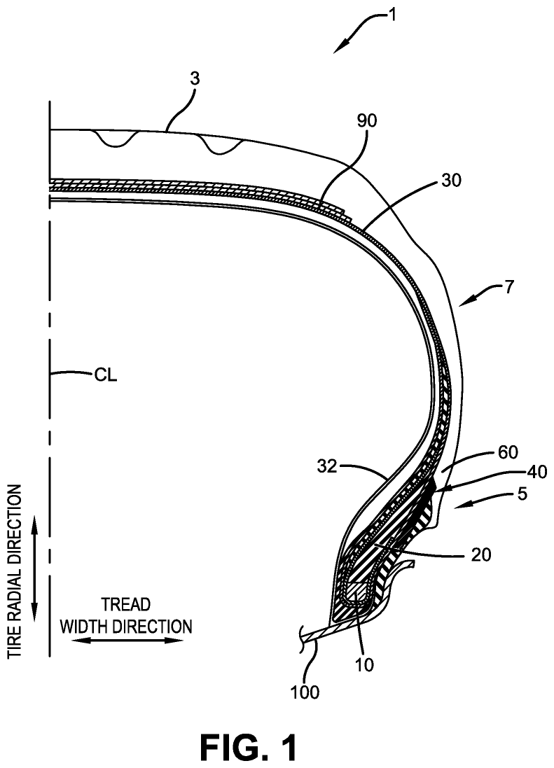

FIG. 1 shows a cross sectional view of a pneumatic or non-pneumatic tire 1 along a tire radial direction and a tread width direction of the tire in accordance with the present invention. The tire 1 may be mounted on a standard rim 100. The tire 1 may have a normal inner pressure and support a normal load. The tire 1 may include a tread portion 3, a bead portion 5, and a side wall portion 7. The tread portion 3 may contact a road surface (not shown).

The tire 1 may further include two bead portions 5 (one shown), a carcass 30, a side rubber layer 60, and a belt portion 90. The carcass 30 may be arranged throughout the tread portion 3, the bead portion 5, and the side wall portion 7. The carcass 30 may extend between a pair of the bead cores 10 (one shown) and a pair of the first bead fillers 20 (one shown). The carcass 30 may curve radially inward to the axially inner side of the bead cores 10 and the first bead fillers 20 and wrap around the axially outer sides of the bead cores 10. Second bead fillers 40 (one shown) may be arranged at the axially outer side of the carcass 30.

The example bead portion 5 may be attached to, or in contact with, the rim 100. The side wall portion 7 may interconnect the tread portion 3 and the bead portion 5. The bead portion(s) 5 may include a bead core 10, a first bead filler 20, a second bead filler 40, a first chafer 50, a flipper 70, and a second chafer 80.

The bead core 10 may allow the attachment of the tire 1 to the rim 100. The bead core 10 be constructed of bead wire (not shown). The first bead filler 20 may be arranged at the radially outer side of the bead core 10. The first bead filler 20 may have an approximate triangular shape.

The first chafer 50 may be arranged at the axially outer side of the bead portion 5. More specifically, the first chafer 50 may be arranged at the axially outer side the carcass 30 and the second bead filler 40. The side rubber layer 60 of the side wall portion 7 may be arranged at the axially outer side of the carcass 30. The second chafer 80 may extend axially between the carcass 30 and an innerliner 32. The second chafer 80 may prevent toe chipping at the rim 100. The belt layer 90 may be arranged in the tread portion 3 at the axially outer side of the carcass 30. The belt layer 90 may include, for example, two belts.

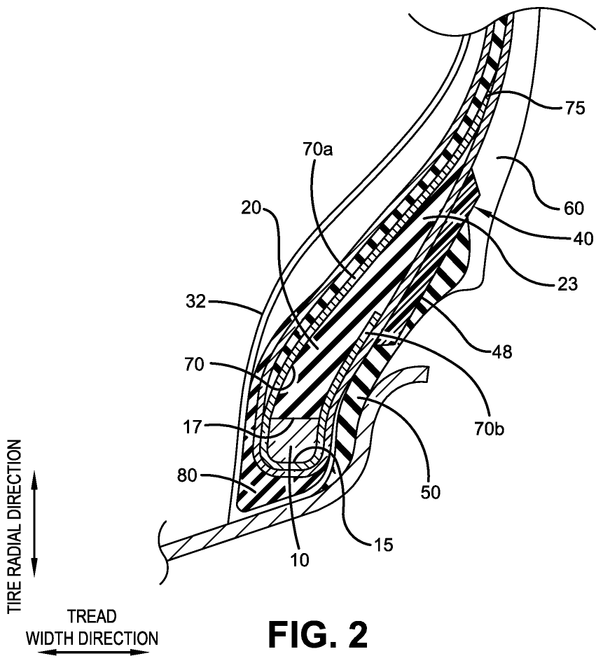

As shown in FIG. 2, the bead portion 5 may include the bead core 10, the first bead filler 20, the carcass 30, the innerliner 32, the second bead filler 40, the first chafer 50, the flipper 70, and the second chafer 80. The bead core 10 may have a bead core-innermost surface 15 which is an innermost surface of the bead core 10 in the tire radial direction. Further, the bead core 10 may have a bead core-outermost surface 17 which is an outermost surface of the bead core 10 in the tire radial direction.

The first bead filler 20 may have a first bead filler outer end portion 23 which is an outer end portion in the tire radial direction of the first bead filler 20. As illustrated in FIG. 2, the thickness of the first bead filler outer end portion 23 may be reduced toward the outer side in the tire radial direction, that is, the first bead filler outer end portion, which is an outermost end of the first bead filler 20 in the tire radial direction. An inner end portion in the tire radial direction of the first bead filler 20 may contact the bead core 10.

The second bead filler 40 may be positioned at the outer side in the tread width direction from the outer carcass 30b. The second bead filler 40 may have a second bead filler outer end portion 43, which is an outer end portion in the tire radial direction, and a second bead filler inner end portion 48, which is an inner end portion in the tire radial direction. As illustrated in FIG. 2, the thickness of the second bead filler 40 may be reduced toward the end portion of the second bead filler 40 in the tire radial direction from the center of the second bead filler 40 in the tire radial direction. That is, the thicknesses of the second bead filler outer end portion 43 and the second bead filler inner end portion 48 may be thinner than that of the center of the second bead filler 40.

The flipper 70 may wrap around the bead core 10 and extend radially outward from the radially inner side of the bead core 10. In the tread width direction, the flipper layer 70 may have an axially inner layer 70a positioned at the inner side of the bead core 10 and an axially outer layer 70b positioned at the outer side of the bead core. A radially outer end 75 of the axially inner layer 70a may extend radially outward to a position axially adjacent the carcass 30 and the first bead filler outer end portion 23. The radially outer end 75 of the axially outer layer 70b may extend radially outward to a position adjacent the first bead filler 20.

The flipper 70 may increase cornering stiffness of tire 1 thereby enhancing dynamic operating conditions, such as ride & handling performance of the tire. Further, such a flipper 70 may provide little or no negative impact to rolling resistance of the tire 1 or other factors, such as manufacturing complexity and cost.

In accordance with the present invention, the second bead filler 40 may extend both axially and radially beyond the first bead filler outer end portion 23 in the tread width direction. Accordingly, the second bead filler 40 overlaps the first bead filler outer end portion 23 in the tread width direction. An outermost end of the second bead filler outer end portion 43 in the tire radial direction may be positioned at the outer side in the tire radial direction radially outward from the first bead filler outer front end 23. The second bead filler inner end portion 48 may be positioned at a radially outer side of the bead core 10. Accordingly, the second bead filler inner end portion 48 may be positioned at the outer side in the tire radial direction from the bead core-outermost surface 17. The second bead filler 40 may contact the carcass 30 at the inner side in the tread width direction. The second bead filler 40 may contact the rubber chafer 50 at the outer side in the tread width direction.

The second bead filler 40 may be embedded at a convergence of the radially outer portion of the first chafer 50 and the radially inner portion of the side rubber layer 60. The second bead filler 40 may thus provide robust load capacity and durability for the bead portion 5. The robust combination of the first bead filler 20, the second bead filler 40, and the flipper 70 may further decrease rolling resistance of the overall tire 1.

The foregoing and other objects, features, and advantages of the present invention will be apparent from the above detailed descriptions of examples of the present invention, as illustrated in the accompanying drawings wherein like reference numbers represent like parts of the present invention. Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A bead portion of a tire comprising:
a bead core;
a first bead filler arranged at a radially outer side of the bead core;
a carcass extending around the bead core and the first bead filler, the carcass extending radially inward adjacent an axially inner side of the bead core, extending axially outward adjacent a radially inner side of the bead core, and extending radially outward adjacent an axially outer side of the bead core;
a second bead filler extending both axially and radially beyond the first bead filler, the second bead filler overlapping the first bead filler, an outermost end of the second bead filler being positioned radially outward from the first bead filler;
a first chafer disposed at an axially outer side of the second bead filler;
a second chafer extended about a radially inner end of the carcass; and
a flipper extending radially inward from a position axially adjacent an axially outer side of the first bead filler,
the second bead filler being embedded at a convergence of the first chafer and a sidewall of the tire.

2. The bead portion as set forth in claim 1 wherein the second bead filler extends both axially and radially beyond a first bead filler outer end portion.

3. The bead portion as set forth in claim 1 wherein the second bead filler overlaps a first bead filler outer end portion.

4. The bead portion as set forth in claim 3 wherein a radially outermost end of the second bead filler outer end portion is positioned at the first bead filler outer end portion.

5. The bead portion as set forth in claim 1 wherein a radially inner end portion of the second bead filler is positioned at a radially outer side of the bead core.

6. The bead portion as set forth in claim 1 wherein a radially inner end portion of the second bead filler is positioned at a radially outermost surface of the bead core.

7. The bead portion as set forth in claim 1 wherein the second bead filler contacts the carcass.

8. The bead portion as set forth in claim 1 wherein the second bead filler contacts the first chafer.

9. The bead portion as set forth in claim 1 wherein the second bead filler is embedded at a convergence of a radially outer portion of the first chafer and a radially inner portion of the side rubber layer.

10. The bead portion as set forth in claim 1 wherein the first bead filler, the second bead filler, and the flipper further decrease rolling resistance of the tire.

11. A method for stiffening a bead portion of a tire, the method comprising the steps of:
arranging a first bead filler at a radially outer side of a bead core;
extending a carcass around the bead core and the first bead filler;
extending the carcass radially inward adjacent an axially inner side of the bead core;
extending the carcass axially outward adjacent a radially inner side of the bead core;
extending the carcass radially outward adjacent an axially outer side of the bead core;
arranging a second bead filler both axially and radially beyond the first bead filler;
overlapping the first bead filler with the second bead filler;
positioning an outermost end of the second bead filler radially outward from the first bead filler;
arranging a first chafer at an axially outer side of the second bead filler; and
embedding the second bead filler at a convergence of the first chafer and a sidewall of the tire.

12. The method as set forth in claim 11 further including the step of extending a second chafer about a radially inner end of the carcass.

13. The method as set forth in claim 11 further including the step of extending a flipper radially inward from a position axially adjacent an axially outer side of the first bead filler.

14. The method as set forth in claim 13 further including the step of extending the flipper axially inward adjacent a radially inner side of the bead core.

15. The method as set forth in claim 14 further including the step of extending the flipper radially outward to a position axially adjacent two separate parts the carcass and a radially outermost end of the first bead filler.
